(19) United States
(12) Patent Application Publication
(10) Pub. No.: US 2016/0314462 A1
(43) Pub. Date: Oct. 27, 2016

(54) SYSTEM AND METHOD FOR AUTHENTICATION USING QUICK RESPONSE CODE

(71) Applicant: SECUVE CO.,LTD., Guro-gu Seoul (KR)

(72) Inventors: Ki-Yoong HONG, Seoul (KR); Jun-Hee SHIN, Seoul (KR)

(21) Appl. No.: 15/104,880

(22) PCT Filed: Nov. 13, 2014
(86) PCT No.: PCT/KR2014/010929

§ 371 Date: Jun. 15, 2016

(30) Foreign Application Priority Data
Dec. 20, 2013 (KR) 10-2013-0160027

(51) Int. Cl. G06Q 20/38; G06K 19/06; G06Q 20/40; G06Q 20/32; G06F 17/30; H04L 29/06

(52) U.S. Cl. CPC G06Q 20/3829; G06F 17/30312; H04L 63/06; H04L 63/083; H04L 63/0428; G06Q 20/38215; G06Q 20/401; G06Q 20/3274; G06K 19/06037; G06K 19/06046; G06Q 2220/00; G06K 2019/06253

(57) ABSTRACT

Provided is a system and method for authenticating a user according to login and financial transactions, such as payment and transfer, and more particularly, to a system and method for authentication using a quick response (QR) code, in which a quick response (QR) code including authentication information is displayed on the computer terminal of a user, the QR code is scanned through a smart device such as a smartphone, and the authentication is performed using the scanned QR code by accessing a QR authentication server included in the QR code.

### BACKGROUND

The present invention generally relates to a user authentication system and method for financial transactions, such as login, payment, stock trade, and money transfer and, more particularly, to an authentication system and method using a Quick Response (QR) code, which display a QR code including authentication information on a user's computer terminal when online authentication is performed, scan the QR code via a smart device, such as a smart phone, and transmit the QR code information of the scanned QR code to a QR authentication server, thus performing authentication.

As the Internet has been universalized and popularized, persons are provided with various types of services over the Internet. As these services, there are services such as commodity purchase, Internet banking, such as account transfers, and information provision services. A person who desires to be provided with such a service must register his or her important information to the system which provides the corresponding service, or must enter the corresponding information whenever the service is used.

By using the fact that each person must enter or register important information so as to be provided with the Internet service in this way, hackers can hack and access the important information of persons, which can result in mental and monetary damage to persons whose information is leaked.

To prevent the leakage of such personal information, various authentication schemes, such as an ID/password login scheme for allocating unique user identification information (IDs) and passwords to respective users and performing authentication using the IDs and passwords, a scheme based on a certificate uniquely generated and used for each person, and a One-Time Password (OTP) authentication scheme for generating a one-time random number and performing authentication, have been developed and applied.

However, as these authentication schemes have been applied, hackers also continue to develop hacking programs or malicious code corresponding to the authentication schemes with the intention of accessing the personal information of Internet users.

Accordingly, the development of authentication schemes capable of more securely protecting personal information has been continuously required. As one of these authentication schemes, Korean Patent No. 10-1245105 entitled “Method and System for Authentication in Electronic Commerce using Smart Phone” (hereinafter referred to as “prior patent”), in which an authentication server generates a barcode or a QR code and displays it on a user's computer and in which the barcode or QR code is scanned using a smart phone and authentication is performed through the authentication server, has been registered and is in use.

However, the prior patent is also problematic in that there is the risk of exposing information about a barcode or a QR code and the risk of leaking personal information when such barcode or QR code information is exposed.

Further, the conventional authentication scheme and the prior patent are problematic in that it is impossible to respond to memory hacking, by which a hacker changes information about an account and an amount of money required for an account transfer via a hacking program and malicious code, thus making it impossible to prevent the occurrence of memory hacking.

### SUMMARY OF THE INVENTION

Accordingly, an object of the present invention is to provide an authentication system and method using a QR code, which display a QR code including authentication information on the computer terminal of a user when online authentication is performed, scan the QR code using a smart device, such as a smart phone, and transmit QR code information of the scanned QR code to a QR authentication server, thus performing authentication.

An authentication system using a Quick Response (QR) code according to the present invention to accomplish the above object includes a computer terminal for making an authentication request by transmitting a QR code authentication request signal including both user identification information of a user and authentication scheme selection information required to select at least QR code authentication, and for displaying a QR code image received in response to the authentication request; a portable authentication terminal for scanning the QR code image and transmitting QR code information contained in the QR code image; a legacy authentication server for requesting generation of a QR code by transmitting a QR code generation request signal, in which QR code generation information including the user identification information is contained, via QR code authentication selected using the authentication scheme selection information for a certain service when the authentication request is made, for transmitting a QR code image received in response to the request to the computer terminal, and for approving provision of the service when received results of QR code authentication indicate success; and a QR authentication server for generating QR code information when the QR code generation request signal is received, generating a QR code image for the QR code information, providing the QR code image to the legacy authentication server, comparing the QR code information received from the portable authentication terminal with QR code information that is generated for the QR code image and is stored in a QR code generation database (DB), performing authentication based on whether pieces of QR code information match each other, and notifying the legacy authentication server of the results of the QR code authentication, wherein the QR authentication server includes a QR storage unit including a QR code generation DB for storing generated QR code information and a QR authentication service subscriber DB for storing authentication service subscription information including user information of the user and ID information and a password of a portable authentication terminal of the user; and a QR control unit for receiving the QR code generation request signal, generating QR code information, storing the QR code information in the QR code generation DB, providing the QR code information to the legacy authentication server, comparing QR code information received from the portable authentication terminal with QR code information stored in the QR code generation DB to perform authentication, and notifying the legacy authentication server of results of the QR code authentication, and the QR control unit may include a QR code authentication service registration unit for, when query about subscription/non-subscription to a QR code authentication service is received from the legacy authentication server in response to a QR code authentication request, determining whether subscription/non-subscription to the service has been made with reference to the authentication service subscription information in the QR authentication service subscriber DB and providing results of the determination to the legacy authentication server, and for, when a service subscription request signal including authentication service subscription information is received from the legacy authentication server, storing and registering the authentication service subscription information in the QR authentication service subscriber DB; a QR code generation unit for, when the QR code generation request signal is received, collecting the QR code information, generating a QR code image for the QR code information, storing the QR code image in the QR code generation DB, and providing the QR code image to the legacy authentication server; a QR authentication unit for comparing the QR code information, which is received from the portable authentication terminal, with QR code information, which is generated for the QR code image and is stored in the QR code generation DB, thus performing authentication; and an authentication result notification unit for notifying both the legacy authentication server and the portable authentication terminal of the results of QR code authentication.

The portable authentication terminal may include a terminal communication unit for performing data communication with the QR authentication server over a wired/wireless data communication network; a scanning unit for scanning the QR code image displayed on the computer terminal and outputting the scanned QR code image; a display unit for displaying the QR code information; and a terminal control unit for detecting QR code information from the QR code image by scanning the QR code image through the scanning unit, displaying the QR code information on the display unit, and transmitting the QR code information.

The QR authentication server may encrypt the QR code information using a security key, generate a QR code image corresponding to encrypted QR code information, and provide the QR code image to the legacy authentication server, and the terminal control unit may include a QR code information acquisition unit for detecting the QR code image through the scanning unit, interpreting the QR code image, and acquiring encrypted QR code information; and a password authentication processing unit having a decryption unit for receiving a password corresponding to the security key from the user and decrypting the acquired encrypted QR code information.

The terminal control unit may further include a QR code integrity checking unit for checking an integrity of the QR code using a hash value included in the decrypted QR code information, and transmitting the QR code information to the QR authentication server when the integrity check is passed.

The terminal control unit may further include a transaction information detection unit for checking whether financial transaction information is included in the decrypted QR code information, and detecting the financial transaction information and displaying the financial transaction information on the display unit if the financial transaction information is included; and a user approval verification unit for, after the financial transaction information has been displayed by the transaction information detection unit, displaying a message prompting the user to decide whether to approve the corresponding transaction, and for, when the user selects approval in response to the prompt message, adding details of the approval to the QR code information and transmitting the QR code information to the QR authentication server.

The user approval verification unit may be configured to, when transmitting the QR code information to the QR authentication server, encrypt again the QR code information using a password and transmit the encrypted QR code information.

The legacy authentication server may include a legacy storage unit, including a legacy authentication information database (DB) for storing pieces of legacy authentication information for respective pieces of user identification (ID) information, and a session ID information DB, for storing authentication service information including pieces of session ID information for respective pieces of user ID information; and a legacy control unit, wherein the legacy control unit may include an authentication type determination unit for determining an authentication request scheme based on the authentication scheme selection information for the authentication request, a legacy authentication unit for performing legacy authentication with reference to the legacy authentication information DB if the authentication request scheme is found to be legacy authentication upon a determination of the authentication type, a QR code authentication service subscription unit for determining whether the user of the user ID information is a subscriber to a QR code authentication service through the QR authentication server if the authentication request scheme is found to be QR code authentication upon a determination of the authentication type, a QR code issuance requesting unit for, when the user is the subscriber to the QR code authentication service, requesting issuance of a QR code by transmitting a QR code generation request signal including the user ID information, and for transmitting a QR code image received in response to the request signal to the computer terminal, wherein the legacy control unit is configured to, when results of QR code authentication depending on transmission of the QR code image are received from the QR authentication server and indicate success, approve provision of the service.

The legacy control unit may further include a session authentication unit for comparing session ID information of user ID information and the session ID information, which are included in the results of the QR code authentication when the QR code authentication results are received, with session ID information registered in a session ID information DB for the user ID information, and performing session authentication based on whether the pieces of session ID information match each other, wherein approval of provision of the service is determined when session authentication succeeds.

The legacy control unit may further include a transaction information authentication unit for, when a type of authentication service for the authentication request is one of a transfer, a purchase and payment, and a stock trade, comparing financial transaction information of user ID information and the financial transaction information included in the authentication results with financial transaction information stored in the session ID information DB for the user ID information, and performing authentication of financial transaction information depending on whether the pieces of financial transaction information match each other, wherein approval of provision of the service is determined when authentication of the financial transaction information succeeds.

The QR code generation unit may include a QR code generation information collection unit for collecting QR code generation information in response to the QR code generation request signal, wherein the QR code generation information includes a site name of a service server, an authentication service type, financial transaction information, user ID information, and session ID information; a QR code information generation unit for generating QR code information that includes the QR code generation information, a timestamp, which is a time of issuance of the QR code, QR ID information, and a hash value; and a QR code image generation unit for generating a QR code image corresponding to the generated QR code information and transmitting the QR code image to the legacy authentication server.

The QR code generation unit may further include a QR code encryption unit for encrypting the generated QR code information using a password registered in a QR authentication service subscriber DB for the user ID information of the QR code generation information, wherein the QR code image generation unit generates a QR code image for the encrypted QR code information.

The QR control unit may further include a terminal authentication unit for, when QR code information is received from the portable authentication terminal, performing authentication based on whether terminal ID information of the portable authentication terminal, which is received from the portable authentication terminal, matches terminal ID information, which is mapped to the user ID information of the user of the portable authentication terminal and is stored in the QR authentication service subscriber DB.

An authentication method using a Quick Response (QR) according to the present invention to accomplish the above object code includes an authentication request procedure of, while a computer terminal is using a certain service provided by a service server, requesting authentication by transmitting a QR code authentication request signal including at least user identification (ID) information and authentication scheme selection information, required to select at least QR code authentication, to a legacy authentication server; a QR code generation request procedure of, when an authentication request is made in response to reception of a QR code authentication request signal including the authentication scheme selection information required to select QR code authentication from the computer terminal, transmitting, by the legacy authentication server, a QR code generation request signal, which includes QR code generation information including the user ID information, to the QR authentication server, thus requesting generation of a QR code; a QR code image generation procedure of, when the QR authentication server receives the QR code generation request signal from the legacy authentication server, collecting QR code information in response to the authentication request, generating a QR code image for the collected QR code information, and providing the QR code image to the legacy authentication server; a QR code provision procedure of transmitting, by the legacy authentication server, the QR code image to the computer terminal; a QR code display procedure of receiving and displaying, by the computer terminal, the QR code image; a QR code scan procedure of scanning, by a portable authentication terminal, the QR code image displayed on the computer terminal, acquiring QR code information included in the QR code, and transmitting the acquired QR code information to the QR authentication server; a QR code authentication procedure of performing, by the QR authentication server, QR code authentication by comparing the QR code information received from the portable authentication terminal with QR code information generated for the user ID information, and transmitting results of QR code authentication to the legacy authentication server; and a service approval procedure of, when the results of the QR code authentication received from the QR authentication server indicate success of authentication, granting, by the legacy authentication server, final approval for the service, wherein the QR code authentication procedure may include a terminal authentication step of comparing terminal ID information included in a signal, containing the QR code information and received from the portable authentication terminal, with terminal ID information previously registered in a QR authentication service subscriber DB to correspond to the user ID information, thus performing terminal authentication based on whether pieces of terminal ID information match each other; a QR code authentication step of, when terminal authentication succeeds, comparing the QR code information with QR code information previously registered for the user of the user ID information, thus performing QR code authentication based on whether pieces of QR code information match each other; and a QR code authentication notification step of transmitting results of QR code authentication to the legacy authentication server.

The authentication scheme selection information in the authentication request procedure may include authentication selection information required to select at least one legacy authentication scheme and a QR code authentication scheme, wherein the QR code generation request procedure may include a legacy authentication step of performing legacy authentication depending on legacy authentication selection information included in the authentication selection information; and a QR code generation request step of requesting generation of a QR code by transmitting a QR code generation request signal, which includes QR code generation information containing the user ID information, to the QR authentication server when legacy authentication succeeds.

The QR code image generation procedure may include a QR code generation information collection step of, when a QR code generation request signal is received from the legacy authentication server, extracting QR code generation information from the QR code generation request signal; a QR code information generation step of generating QR code information, which includes the collected QR code generation information and information about a QR code to be generated; and a QR code image generation step of generating a QR code image corresponding to the generated QR code information, and thereafter providing the QR code image to the legacy authentication server.

The QR code image generation procedure may further include an encryption step of, when QR code information is collected at the QR code generation information collection step, encrypting the QR code information by applying a password of the corresponding user, registered in the QR authentication service subscriber DB, to the QR code information as a security key, wherein, at the QR code image generation step, a QR code image for the encrypted QR code information is generated.

The QR code scan procedure may include a scanning step of scanning, by the portable authentication terminal, a QR code image displayed on the computer terminal; a QR code information extracting step of analyzing the scanned QR code image and extracting QR code information; and a QR code transmission step of transmitting the extracted QR code information to the QR authentication server.

In the QR code image generation procedure, the QR authentication server may encrypt QR code information using a password preset for the user of the user ID information as a security key, and transmit the encrypted QR code information, and the QR code scan procedure may further include a decryption step of, after the QR code information has been extracted, requesting the user to input a password corresponding to the security key and receiving the password from the user, and then decrypting the encrypted QR code information using the password.

The QR code scan procedure may further include an integrity checking step of performing an integrity check using a hash value included in the QR code information, and the QR code information is transmitted to the QR authentication server only when the integrity check at the QR code transmission step is passed.

The service approval procedure may include a session authentication step of, when results of QR code authentication are received from the QR authentication server, performing, by the legacy authentication server, session authentication based on whether session ID information included in the results of the QR code authentication matches session ID information stored in a session ID information DB to correspond to the user authentication information included in the results of the QR code authentication; and a service approval step of granting final approval for the service when session authentication succeeds.

The service approval procedure may further include a transaction information authentication step of, when a type of authentication service in the authentication request is a financial transaction, comparing financial transaction information included in the results of QR code authentication with financial transaction information that is stored in the session ID information DB and is mapped to the session ID information, thus performing authentication of transaction information based on whether pieces of financial transaction information match each other, and the service approval step may be performed when authentication of the transaction information succeeds.

The present invention is advantageous in that QR code information converted into a QR code is encrypted using a security key, and thus the QR code may be doubly protected, and the leakage of information contained in the QR code may be prevented even if the QR code is exposed.

Further, the present invention is advantageous in that detailed authentication information, such as the details of an account transfer, is included in a QR code, and in that, when a user scans the QR code using his or her smart device, he or she receives a security key (password) required to decrypt the QR code, checks information about finally applied authentication details, verifies a hash value, and determines whether the forgery/falsification of the QR code has occurred, thus allowing the user to determine whether memory hacking has occurred in an intermediate procedure.

Furthermore, the present invention is advantageous in that the authentication of a user device is performed using the unique terminal identification information of a portable authentication terminal, such as a smart device, thus enabling security to be doubly maintained.

Furthermore, the present invention is advantageous in that authentication is performed using a session ID, thus enabling security to be doubly maintained.

### BRIEF DESCRIPTION OF DRAWINGS

FIG. 1 is a diagram showing the configuration of an authentication system using a QR code according to the present invention;

FIG. 2 is a diagram showing the configuration of the portable authentication terminal of the authentication system according to the present invention;

FIG. 3 is a diagram showing the configuration of the legacy authentication server of the authentication system according to the present invention;

FIG. 4 is a diagram showing the configuration of the QR authentication server of the authentication system according to the present invention;

FIG. 5 is a flowchart showing an authentication method using a QR code in the authentication system according to a first embodiment of the present invention;

FIG. 6 is a flowchart showing an authentication method using a QR code in the authentication system according to a second embodiment of the present invention; and

FIG. 7 is a flowchart showing a method for registering a user password and portable authentication terminal identification information for the authentication method using a QR code in the authentication system according to embodiments of the present invention.

### DETAILED DESCRIPTION OF THE INVENTION

Hereinafter, the configuration and operation of an authentication system using a QR code according to the present invention will be described and an authentication method performed by the system will also be described with reference to the attached drawings.

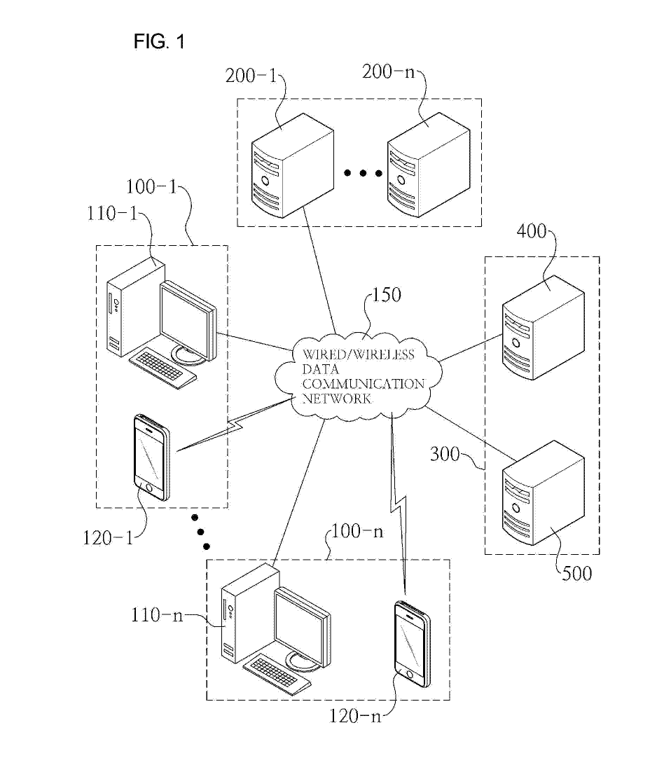

FIG. 1 is a diagram showing the configuration of an authentication system using a QR code according to the present invention.

The authentication system using a QR code according to the present invention includes a user terminal unit 100 and an authentication server unit 300.

The user terminal unit 100, a service server 200, and the authentication server unit 300 are connected to each other over a wired/wireless data communication network 150 to perform data communication in a wired or wireless manner.

The wired/wireless data communication network 150 is a network composed of one or more of the Internet including a WiFi network, a third generation (3G) mobile communication network, and a fourth generation (long term evolution: LTE) mobile communication network.

The user terminal unit 100 includes a computer terminal 110 and a portable authentication terminal 120.

The computer terminal 110 may include a Personal Computer (PC), a notebook computer, a tablet PC, a smart pad, a smart phone, or the like, and is configured to access the service server 200 according to the present invention, display a QR code image so as to perform authentication that is required in order to be provided with arbitrary service, and provide a screen pertaining to the service when the authentication of the QR code image succeeds.

The portable authentication terminal 120, which is a device including a scanning means capable of scanning the QR code image displayed on the computer terminal 110, may be a smart device, such as a smart pad or a smart phone having unique terminal identification information. The terminal identification information may be one or more of a phone number, an International Mobile Equipment Identity (IMEI), and an Electronic Serial Number (ESN). The portable authentication terminal 120 scans the QR code image displayed on the computer terminal 110 according to the present invention, acquires and displays QR code information contained in the QR code image, shows the acquired QR code information to the user, and provides the QR code information to the authentication server unit 300.

The service server 200 may be an information provision server for providing arbitrary information, a financial server for providing an Internet banking service, such as an account transfer, an electronic commerce (E-commerce) server for enabling commodities to be purchased and processing payment for the commodities, or the like, and performs authentication through the authentication server unit 300 to process a login procedure, an account transfer, payment, etc. Hereinafter, the service requiring authentication, such as the login, account transfer, and payment, is referred to as “authentication service”.

When an authentication request for authentication service is received from the service server 200, the authentication server unit 300 performs authentication of the user of the user terminal unit 100. The authentication server unit 300 includes a legacy authentication server 400 for performing one or more of login authentication based on a user's ID and password, certificate authentication based on a certificate, and OTP authentication based on an OTP, and a QR (code)authentication server 500 for generating QR code information and generating and issuing a QR code image containing the QR code information according to the present invention, and, when QR code information for the issued QR code image is received from the portable authentication terminal 120, comparing the issued QR code information with the received QR code information, and then performing authentication. The QR code information includes a message including details related to authentication, information about an encryption scheme such as Base64 and AES256, information about the site of the service server 200, authentication service type information, transaction information, user identification information (userID), session identification information (session ID), a timestamp, a hash value, etc. The authentication service type information may be information about whether the authentication service initiating this authentication is a login or a financial transaction such as an account transfer, payment, or stock trade. The information about the financial transaction (hereinafter referred to as “financial transaction information”) may include multiple pieces of information among bank transit information, account information (sender/recipient accounts), transfer amount information, and transfer sender/recipient information when the service type is an account transfer service, and may include multiple pieces of information among card company information, a card number, and payment amount information when the service type is a payment service. To prevent memory hacking, the financial transaction information may preferably include bank transit information, account information, and transfer amount information when the type of authentication service is a transfer service, and may preferably include payment amount information when the type of authentication service is a payment service.

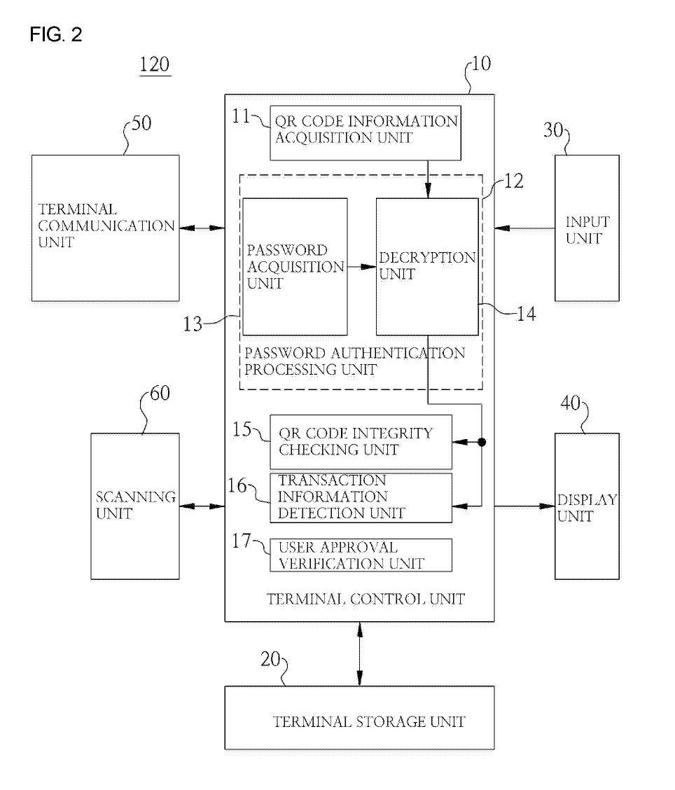

FIG. 2 is a diagram showing the configuration of the portable authentication terminal of the authentication system according to the present invention. Below, the configuration of the portable authentication terminal will be described in detail with reference to FIG. 2.

The portable authentication terminal 120 includes a terminal control unit 10, a terminal storage unit 20, an input unit 30, a display unit 40, a terminal communication unit 50, and a scanning unit 60.

The terminal storage unit 20 includes a program area for storing a control program required to control the operation of the portable authentication terminal 120 according to the present invention, a temporary area for temporarily storing data generated during the execution of the program, and a user data area for storing each QR code image and QR code information, scanned according to the present invention, and detailed authentication information such as financial transaction information according to a second embodiment.

The input unit 30 includes one or more of a button input unit, which is provided with buttons for function selection, volume control, and power/screen on/off control and is configured to output a button signal for a pressed button to the terminal control unit 10, a key input unit, which is provided with multiple keys enabling multiple characters to be input and functions to be selected and is configured to output a key signal for a pressed key to the terminal control unit 10, and a touch pad, which is configured to be integrated with the screen of the display unit 40, to generate coordinate data for a touched location, and to output the coordinate data to the terminal control unit 10.

The display unit 40 displays the state of operation of the portable authentication terminal 120, displays a QR code scan interface means according to the present invention, and displays one or more of a QR code image and QR code information scanned through the scan interface means.

The terminal communication unit 50 is connected to the wired/wireless data communication network 150 in a wireless manner to provide data communication with the service server 200, and the legacy authentication server 400 and the QR authentication server 500 of the authentication server unit 300, which are connected to the wired/wireless data communication network 150.

The scanning unit 60 includes a camera and outputs a captured image, obtained by capturing the screen of the computer terminal 110 according to the present invention, to the terminal control unit 10.

The terminal control unit 10 includes a QR code information acquisition unit 11, a password authentication processing unit 12, and a QR code integrity checking unit 15 according to a first embodiment of the present invention, further includes a transaction information detection unit 16 and a user approval verification unit 17 according to a second embodiment, and controls the overall operation according to the first and second embodiments of the present invention.

More specifically, the QR code information acquisition unit 11 acquires a QR code image from an image input from the scanning unit 60 by controlling the scanning unit 60, and acquires QR code information by interpreting the QR code image. Here, the QR code information may be encrypted using a security key.

The password authentication processing unit 12 is configured to, when the QR code information is encrypted using the security key, decrypt the QR code information encrypted using the security key, and includes a password acquisition unit 13 for acquiring and outputting a password corresponding to the security key through the input unit 30, and a decryption unit 14 for decrypting the QR code information using the acquired password.

The QR code integrity checking unit 15 receives the QR code information, decrypted by the decryption unit 14, performs an integrity check based on a hash value included in the QR code information, displays a message, contained in the QR code information, on the display unit 40 when the integrity check succeeds, and transmits the message to the QR authentication server 500 of the authentication server unit 300 through the terminal communication unit 50.

The second embodiment of the present invention further includes the transaction information detection unit 16 and the user approval verification unit 17 in order for the user to determine whether any change is made in transaction details through the portable authentication terminal to prevent memory hacking when the type of authentication service is the service in which the personal property of respective persons is directly traded, such as in a transfer and a payment, and in order for the portable authentication terminal to transmit QR code information to the QR authentication server 500 only when the user's approval is obtained.

When financial transaction information is included in the decrypted QR code information, the transaction information detection unit 16 detects the financial transaction information and displays it on the display unit 40. The financial transaction information may include bank information, card company information, account information, a card number, transfer amount information, payment amount information, transfer recipient information, a delivery address, etc. depending on the type of authentication service.

After the transaction information detection unit 16 displays the financial transaction information, the user authentication verification unit 17 displays a message asking the user to finally approve or reject the displayed financial transaction information on the display unit 40, and transmits the QR code information to the QR authentication server 500 when approval is selected in response to the message. In contrast, when the user denies the approval, the user approval verification unit 17 may be configured to terminate the operation or transmit a rejection signal to the QR authentication server 500.

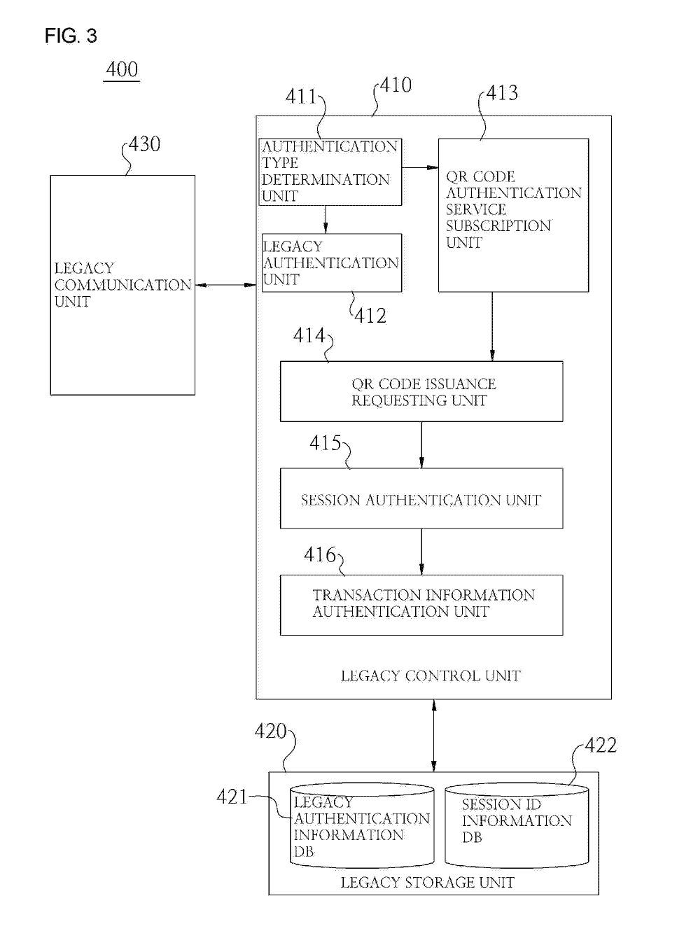

FIG. 3 is a diagram showing the configuration of the legacy authentication server of the authentication system according to the present invention. Hereinafter, the configuration of the legacy authentication server will be described in detail with reference to FIG. 3.

The legacy authentication server 400 includes a legacy control unit 410, a legacy storage unit 420, and a legacy communication unit 430.

The legacy storage unit 420 includes a legacy authentication information DB 421 for storing one or more of ID/password-based login information, certificate-based public certification information, and OTP-based OTP authentication information, and a session ID information DB 422 for storing both session identification information (Session ID) related to the connection of the session that is being authenticated, and authentication service information, which is mapped to the session ID information and includes user ID information, financial transaction information, etc.

The legacy communication unit 430 accesses the wired/wireless data communication network 150 and performs data communication with the computer terminal 110, the QR authentication server 500, etc., which are connected to the wired/wireless data communication network 150.

The legacy control unit 410 includes an authentication type determination unit 411, a legacy authentication unit 412, a QR code authentication service subscription unit 413, a QR code issuance requesting unit 414, a session authentication unit 415, and a transaction information authentication unit 416, and controls the overall operation of the legacy authentication server 400.

More specifically, the authentication type determination unit 411 is configured to, when an authentication request for an arbitrary service is received from the computer terminal 110 of the user through the corresponding service server 200, determine the type of authentication service for which authentication is requested so as to be provided with the service, and activate one or more of the legacy authentication unit 412 and the QR code authentication service subscription unit 413 based on the results of the determination. The user may request only QR code authentication, or may simultaneously request both legacy authentication and QR code authentication according to the present invention through the computer terminal 110. The term “legacy authentication” means conventional well-known authentication, such as the above-described login authentication, certificate authentication, and OTP authentication.

The legacy authentication unit 412 is activated by the authentication type determination unit 411, and performs authentication by comparing the authentication information received from the computer terminal 110 through the legacy communication unit 430 with authentication information stored in the legacy authentication information DB 421.

The QR code authentication service subscription unit 413 is activated by the authentication type determination unit 411 and queries the QR authentication server 500 as to whether the user who requests the authentication of the QR code is a QR authentication service subscriber, and thus determines whether the user is a service subscriber. As a result, if the user is found not to be a service subscriber, the QR code authentication service subscription unit 413 provides a message, prompting the user to decide whether to subscribe to the QR code authentication service, to the computer terminal 110 through the legacy communication unit 430, provides a QR code authentication service subscription (registration) means when the subscription is requested, collects QR code authentication service subscription information, and transmits the collected information to the QR authentication server 500, thus requesting registration of the service. Further, when the user is determined to be a service subscriber, the QR code authentication service subscription unit 413 activates the QR code issuance requesting unit 414. The QR code authentication service subscription information includes a password, used as a security key required for encryption of QR code information of the user and the terminal ID information of the portable authentication terminal 120 of the user.

The QR code issuance requesting unit 414 generates a QR code issuance request signal, including authentication service information about the authentication service performed through the service server 200, and transmits the QR code issuance request signal to the QR authentication server 500. The authentication service information includes the type of authentication service, the site information of the service server, financial transaction information, user ID information, session ID information, etc. The QR code issuance requesting unit 414 transmits a QR code image, received after the issuance of the QR code is requested, to the computer terminal 110.

The session authentication unit 415 compares session ID information, contained in the received results of QR code authentication when the results of QR code authentication are received from the QR authentication server 500, with the session ID information stored in the session ID information DB 422 for the authentication of the corresponding QR code, and then performs session authentication depending on whether pieces of session ID information match each other. When session authentication succeeds, final approval for the authentication request is determined, and notification of final approval is provided to the service server 200. However, when session authentication fails, the session authentication unit 415 transmits information about the failure of session authentication to the service server 200 and to the QR authentication server 500.

In accordance with the second embodiment of the present invention, the session authentication unit 415 activates the transaction information authentication unit 416 when session authentication succeeds.

The activated transaction information authentication unit 416 loads the financial transaction information corresponding to the session ID information included in the results of QR authentication from the session identification information DB 422, and performs a comparison to check whether the loaded financial transaction information matches financial transaction information contained in the results of QR authentication. When the pieces of financial transaction information match each other, the transaction information authentication unit 416 determines final approval of the authentication request, and notifies the service server 200 and the QR authentication server 500 of the determination of final approval.

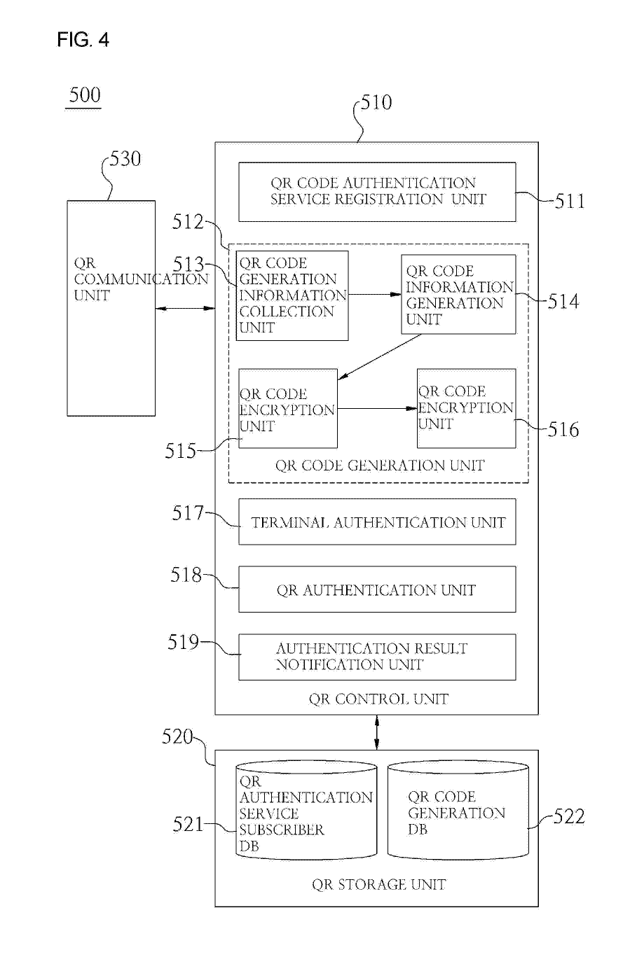

FIG. 4 is a diagram showing the configuration of the QR authentication server of the authentication system according to the present invention.

Referring to FIG. 4, the QR authentication server 500 according to the present invention includes a QR control unit 510, a QR storage unit 520, and a QR communication unit 530.

The QR storage unit 520 includes a QR authentication service subscriber DB 521 for storing information about QR code authentication service subscribers and a QR code generation DB 522 for storing pieces of QR code information and generated QR code images for respective authentication requests. The authentication service subscriber information includes both the terminal ID information of the portable authentication terminal of each user and a password used as a security key.

The QR communication unit 530 accesses the wired/wireless data communication network 150 and performs data communication with the legacy authentication server 400 and the portable authentication terminal 120, which are connected to the wired/wireless data communication network 150.

The QR control unit 510 includes a QR code authentication service registration unit 511, a QR code generation unit 512, a terminal authentication unit 517, a QR authentication unit 518, and an authentication result notification unit 519, and controls the overall operation of the QR authentication server 500.

More specifically, the QR code authentication service registration unit 511 determines whether a certain user has subscribed to the QR code authentication service with reference to the QR authentication service subscriber DB 521 when the legacy authentication server 400 queries the QR code authentication service registration unit 511 as to whether the corresponding user has subscribed to the QR code authentication service, notifies the legacy authentication server 400 of the results of the determination, and stores information about subscription to the QR code authentication service in the QR authentication service subscriber DB 521 and registers the corresponding user as a service subscriber when the information about the subscription to the QR code authentication service is received from the legacy authentication server 400.

The QR code generation unit 512 includes a QR code generation information collection unit 513, a QR code information generation unit 514, a QR code encryption unit 515, and a QR code image generation unit 516, generates a QR code, that is, a QR code image, and provides the generated QR code to the legacy authentication server 400.

The QR code generation information collection unit 513 collects authentication service information, received from the legacy authentication server 400 through the QR communication unit 530, as QR code generation information, and outputs the QR code generation information.

The QR code information generation unit 514 generates QR code information including both the authentication service information, collected by the QR code generation information collection unit 513, and information related to the QR code to be generated, such as generation time information (timestamp), QR ID information (QRID), and a hash value.

The QR code encryption unit 515 encrypts and outputs the QR code information by applying the user's password, registered in the QR authentication service subscriber DB 521, as a security key.

The QR code image generation unit 516 receives the encrypted QR code information input from the QR code encryption unit 515 or unencrypted QR code information input from the QR code information generation unit 514, generates a QR code image, and provides the QR code image to the legacy authentication server 400. The QR code image for the encrypted QR code information and the QR code image for the unencrypted QR code information may be different from each other.

When a QR code authentication request signal including QR code information and terminal ID information is received from the portable authentication terminal 120, the terminal authentication unit 517 performs a comparison to check whether the terminal ID information included in the QR code authentication request signal matches terminal ID information included and stored in the QR authentication service subscriber information of the user corresponding to the user ID information of the QR code information, and then authenticates the terminal.

The QR authentication unit 518 may be configured to perform QR authentication when the terminal has been successfully authenticated by the terminal authentication unit 517, or may perform QR authentication separately from the terminal authentication. The QR authentication unit 518 performs QR authentication by determining whether pieces of information in the QR code information issued thereby match pieces of information in the received QR code information.

When QR authentication is successfully performed by the QR authentication unit 518, the authentication result notification unit 519 notifies both the legacy authentication server 400 and the portable authentication terminal 120 of the success of authentication.

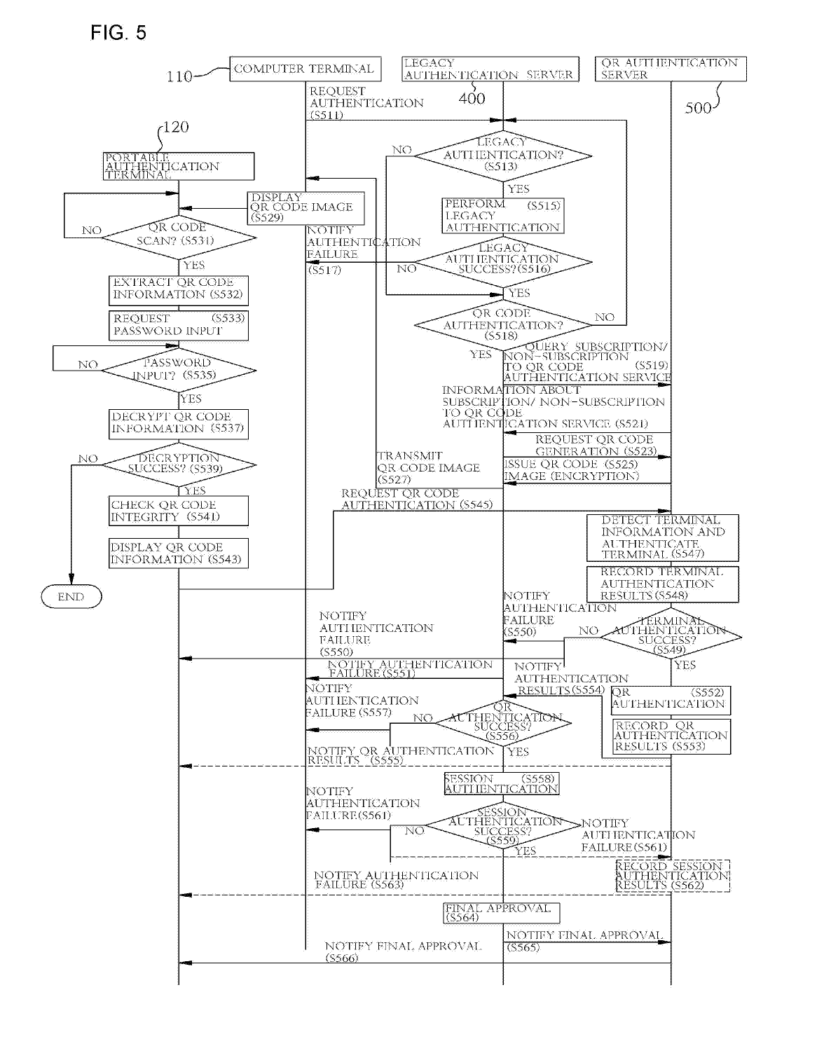

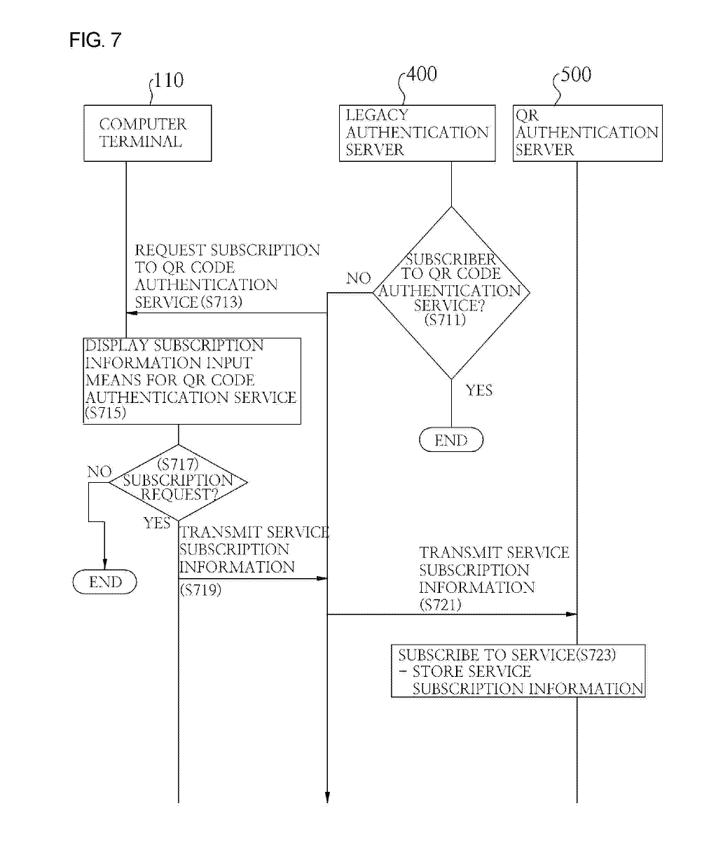

FIG. 5 is a flowchart showing an authentication method using a QR code in the authentication system according to a first embodiment of the present invention, and FIG. 7 is a flowchart showing a method for registering a user password and portable authentication terminal identification information for the authentication method using a QR code in the authentication system according to embodiments of the present invention. Below, a description will be made with reference to FIGS. 5 and 7.

First, the computer terminal 110 requests authentication required to be provided with an arbitrary service through the service server 200 (S511).

When an authentication request is made, the legacy authentication server 400 stores session ID information, related to the connection of a session with the computer terminal 110, and authentication service information of the service server 200 for the session ID information, and determines whether the authentication request is a single QR code authentication request or a dual authentication request for requesting both legacy authentication and QR code authentication (S513, S518).

When the authentication request is a dual authentication request, the legacy authentication server 400 performs legacy authentication (S515), determines whether legacy authentication succeeds (S516), and transmits a signal for querying the QR authentication server 500 as to whether subscription to the QR code authentication service has been made to the QR authentication server 500 if the authentication succeeds (S519). When only the QR code authentication is selected, the legacy authentication server 400 immediately transmits a subscription/non-subscription query signal for the QR code authentication service to the QR authentication server 500 without performing legacy authentication. In the above description, although the case where one or more of QR code authentication and legacy authentication are selectively performed has been described, it is apparent that the present invention may be configured to perform only QR code authentication. When legacy authentication fails, the legacy authentication server 400 may notify the computer terminal 110 of the failure of authentication (S517).

When the subscription/non-subscription query for the QR code authentication service is received from the legacy authentication server 400, the QR authentication server 500 checks whether the user corresponding to the user ID information contained in the query is registered in the QR authentication service subscriber DB 521, determines whether the user has subscribed to the service, and provides information about subscription/non-subscription to the QR code authentication service, which includes the results of the determination, to the legacy authentication server 400 (S521).

The legacy authentication server 400, having received the information about subscription/non-subscription to the QR code authentication service, determines, based on the information about subscription/non-subscription to the QR code authentication service, whether the corresponding subscriber is a subscriber to the QR code authentication service in FIG. 7 (S711).

As a result of the determination, when the subscriber is found to be a subscriber to the QR code authentication service, the legacy authentication server 400 transmits a QR code request signal, which includes authentication service information including information such as user ID information, session ID information, an authentication service type, and transaction details, and which requests the generation of a QR code, to the QR code server 500 (S523).

In contrast, when the subscriber is not a subscriber to the QR code authentication service, the legacy authentication server 400 transmits a QR code authentication service subscription request signal, including a QR code authentication service subscription information input means, to the computer terminal 110 (S713).

The computer terminal 110 displays the authentication service subscription information input means (S715) and checks whether a subscription request command is issued (S717).

When the subscription request command is issued, the computer terminal 110 transmits a service subscription request signal, including service subscription information that is input through the authentication service subscription information input means, to the legacy authentication server 400 (S719).

The legacy authentication server 400, having received the service subscription request signal, transmits the service subscription request signal, which includes the service subscription information, to the QR authentication server 500 (S721).

When the service subscription request signal is received from the legacy authentication server 400, the QR authentication server 500 stores the service subscription information, included in the service subscription request signal, in the QR authentication service subscriber DB 521, and thus processes subscription to the service (S723).

Further, the QR authentication server 500, having received the QR code generation request signal, generates QR code information, also generates a QR code image for the QR code information, and provides the generated QR code information and QR code image to the legacy authentication server 400 (S525). In this case, after the QR code information has been encrypted using a security key corresponding to the password set by the user, the encrypted QR code information may be converted into a QR code image. In order to improve security, it is preferable to convert the QR code information into a QR code image after the QR code information has been encrypted.

The legacy authentication server 400, having received the QR code image, transmits the QR code image to the computer terminal 110 (S527).

Further, the computer terminal 110, having received the QR code image, displays the QR code image on the screen (S529).

When the QR code image is displayed on the computer terminal 110, the user may scan the QR code image on the screen using the portable authentication terminal 120. For this, when the user runs a QR code scan application installed on the portable authentication terminal 120, whether the QR code is scanned is checked (S531).

When the QR code image is scanned through the scanning unit 60, the terminal control unit 10 of the portable authentication terminal 120 extracts QR code information from the QR code image (S532).

When the QR code is extracted, the terminal control unit 10 checks the integrity of the QR code (S541), displays the QR code information on the display unit 40 (S543), and transmits a QR code authentication request signal, including the QR code information, to the QR authentication server 500 (S545). When the checking of integrity fails, the process may be immediately terminated or, alternatively, notification of the failure of the integrity check may be provided to the QR authentication server 500 (not shown).

However, when the QR code information has been encrypted using a security key, the portable authentication terminal 120 requests the input of a password corresponding to the security key through the display unit 40 (533), and checks whether the password has been input (S535).

When the password has been input, the portable authentication terminal 120 decrypts the encrypted QR code information using the input password (S537) and thereafter checks whether decryption succeeds (S539).

When decryption succeeds, the portable authentication terminal 120 may check the integrity of the above-described QR code.

The QR authentication server 500, having received the QR code authentication request signal, detects the terminal ID information included in the QR code authentication request signal and compares the detected terminal ID information with the terminal ID information registered in the QR authentication service subscriber DB 521, thus performing terminal authentication (S547).

After the terminal has been authenticated, the QR authentication server 500 records the results and details of authentication of the terminal (S548).

After recording the authentication results, the QR authentication server 500 determines whether authentication of the terminal succeeds (S549).

When the authentication of the terminal is found to succeed upon the determination of terminal authentication, the QR authentication server 500 performs QR authentication (S552), whereas when it is determined that the authentication of the terminal fails, the QR authentication server 500 notifies both the legacy authentication server 400 and the portable authentication terminal 120 of the failure of terminal authentication (S550). Here, the legacy authentication server 400, having received the notification of the failure of terminal authentication, notifies the computer terminal 110 of the failure of terminal authentication (S551).

After QR authentication has been performed, the QR authentication server 500 stores the results and details of QR authentication (S553), and thereafter notifies the legacy authentication server 400 of the results of authentication including both the QR ID information (QR ID) and the session ID information (Session ID)(S554). When the QR authentication fails, the QR authentication server 500 may be configured to notify the portable authentication terminal 120 of the failure of authentication (S555).

When the results of authentication are received from the QR authentication server 500, the legacy authentication server 400 analyzes the results of authentication and determines that QR authentication succeeds (S556).

When QR authentication fails, the legacy authentication server 400 notifies the computer terminal 110 of the failure of authentication (S557).

On the other hand, when authentication succeeds, the legacy authentication server 400 compares session ID information included in the results of authentication with session ID information that is stored in the session ID information DB 422 and corresponds to the QR ID information, thus performing session authentication (S558).

After session authentication has been performed, the legacy authentication server 400 determines whether session authentication succeeds (S559). When session authentication fails, the legacy authentication server 400 notifies the computer terminal 110 of the failure of authentication (S561). Here, the legacy authentication server 400 may be configured to notify the QR authentication server 500 of the results of authentication (S561). Further, the QR authentication server 500 may be configured to record the details of the failure of session authentication when providing notification of the failure of session authentication (S562), and may notify the portable authentication terminal 120 of the failure of session authentication (S563).

On the other hand, when session authentication succeeds, the QR authentication server 500 grants final approval for the authentication request S511 (S564). Further, the corresponding service server 200 may perform the corresponding service, login, transfer, etc.

After final approval has been granted, the legacy authentication server 400 transmits a final approval notification signal, indicating that authentication has been finally approved, to the QR authentication server 500 (S565).

The QR authentication server 500, having received the final approval notification signal, transmits an authentication result notification signal to the portable authentication terminal 120 (S566).

The portable authentication terminal 120, having received the authentication result notification signal, may display information about the results of authentication.

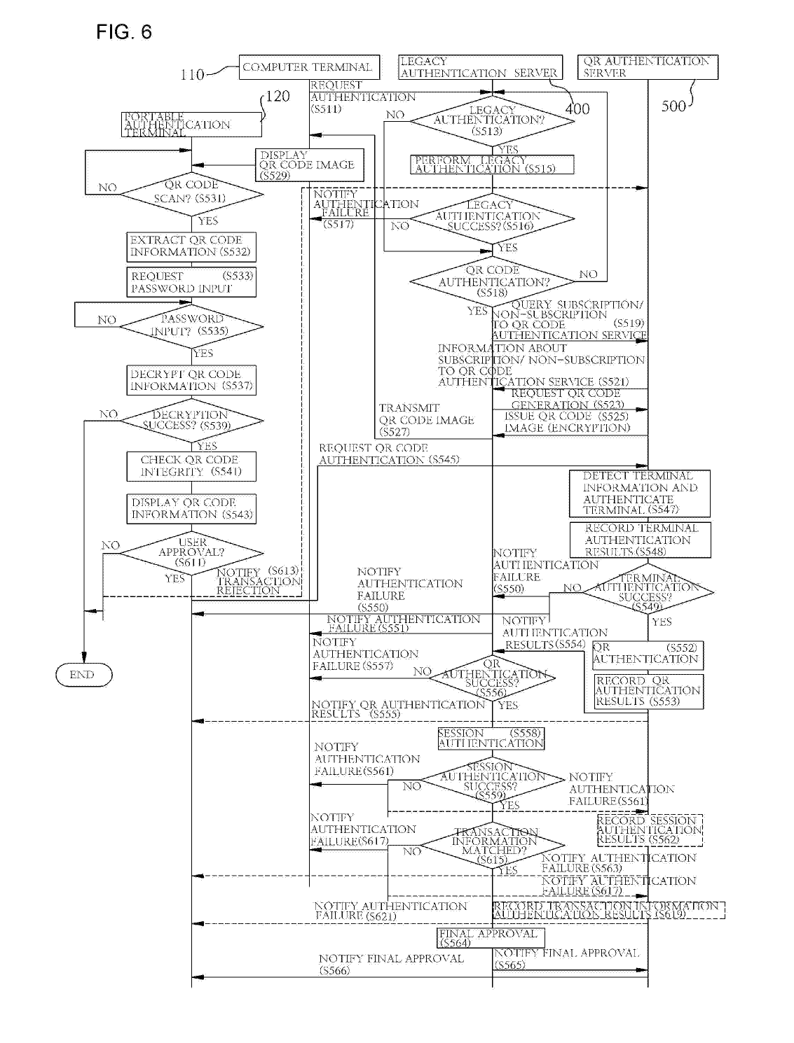

FIG. 6 is a flowchart showing an authentication method using a QR code in the authentication system according to a second embodiment of the present invention. In the description made with reference to FIG. 6, the same reference numerals are assigned to procedures identical to those of FIG. 5, and a description thereof will be omitted, or will be briefly made.

Referring to FIG. 6, the second embodiment relates to the case where the type of authentication service includes financial transaction information, such as a transfer and a payment, and is configured to prevent harm to the user attributable to memory hacking by checking transaction details based on a transfer or the like through the user's portable authentication terminal 120.

For this, the portable authentication terminal 120 includes financial transaction information depending on the type of authentication service in QR code information, checks the integrity of the QR code based on the QR code information (S541), and then displays the QR code information (S543).

After the QR code information including the financial transaction information has been displayed, the portable authentication terminal 120 outputs a message prompting the user to decide whether to continue with the transaction, and checks whether the user selects ‘approve’ (S611).

When the user approves continuance of the transaction, the portable authentication terminal 120 transmits a QR code authentication request signal including the QR code information to the QR authentication server 500 (S545). Here, the QR code information may also be encrypted again using the input password, and may then be transmitted.

Further, when the user rejects the transaction for the financial transaction information, the portable authentication terminal 120 may be configured to immediately terminate the transaction, or transmit a rejection notification signal, indicating that the transaction for the financial transaction information has been rejected, to the QR authentication server 500 (S613). In the former case, the QR authentication server 500 notifies the legacy authentication server 400 that the transaction has been rejected after a predetermined period of time has elapsed. In the latter case, when the rejection notification signal is received, the QR authentication server 500 may notify the legacy authentication server 400 that the transaction has been rejected (not shown). The legacy authentication server 400, having received the rejection notification signal, will finally reject the service corresponding to the authentication request S511.

Further, in a transaction such as a transfer or a payment, a change of account information or an address or a change in the amount of money may greatly damage the user. In order to doubly prevent such damage, the legacy authentication server 400 further performs a comparison to determine whether the QR ID information and the financial transaction information included in the authentication result notification signal when session authentication succeeds (S559) match the financial transaction information registered in the session ID information DB 422 for the QR ID information (S615).

The legacy authentication server 400 notifies the computer terminal 110 and the QR authentication server 500 of the failure of authentication (S617) when the pieces of financial transaction information do not match each other, and grants final approval only when the pieces of financial transaction information match each other, thus preventing the occurrence of memory hacking (S559). The QR authentication server 500 stores the results and details of authentication when the authentication fails due to the mismatch of the financial transaction information (S619), and notifies the portable authentication terminal 120 that authentication fails due to the mismatch of financial transaction information (S621).

Meanwhile, the present invention is not limited to the above-described typical preferable embodiments, and those skilled in the art will appreciate that various modifications, changes, substitutions, or additions are possible, without departing from the gist of the invention. The technical spirit of those modifications, changes, substitutions, or additions may be construed as being included in the present invention if the practice thereof belongs to the scope of the accompanying claims.

### DESCRIPTION OF THE REFERENCE NUMERALS

10: terminal control unit 11: QR code information acquisition unit

12: password authentication processing unit 13: password acquisition unit

14: decryption unit 15: QR code integrity checking unit

16: transaction information detection unit 17: user approval verification unit

20: terminal storage unit 30: input unit

40: display unit 50: terminal communication unit

60: scanning unit 100: user terminal unit

110: computer terminal 120: portable authentication terminal

200: service server 300: authentication server unit

400: legacy authentication server 410: legacy control unit

411: authentication type determination unit 412: legacy authentication unit

413: QR code authentication service subscription unit

414: QR code issuance requesting unit

415: session authentication unit

416: transaction information authentication unit

420: legacy storage unit

421: legacy authentication information DB

422: session identification information

DB 430: legacy communication unit

500: QR authentication server 510: QR control unit

511: QR code authentication service registration unit

512: QR code generation unit

513: QR code generation information collection unit

514: QR code information generation unit

515: QR code encryption unit 516: QR code image generation unit

517: terminal authentication unit 518: QR authentication unit

519: authentication result notification unit

520: QR storage unit

521: QR authentication service subscriber DB

522: QR code generation DB 530: QR communication unit

1. An authentication system using a Quick Response (QR) code, comprising:
a computer terminal for making an authentication request by transmitting a QR code authentication request signal including both user identification information of a user and authentication scheme selection information required to select at least QR code authentication, and for displaying a QR code image received in response to the authentication request;
a portable authentication terminal for scanning the QR code image and transmitting QR code information contained in the QR code image;
a legacy authentication server for requesting generation of a QR code by transmitting a QR code generation request signal, in which QR code generation information including the user identification information is contained, via QR code authentication selected using the authentication scheme selection information for a certain service when the authentication request is made, for transmitting a QR code image received in response to the request to the computer terminal, and for approving provision of the service when received results of QR code authentication indicate success; and
a QR authentication server for generating QR code information when the QR code generation request signal is received, generating a QR code image for the QR code information, providing the QR code image to the legacy authentication server, comparing the QR code information received from the portable authentication terminal with QR code information that is generated for the QR code image and is stored in a QR code generation database (DB), performing authentication based on whether pieces of QR code information match each other, and notifying the legacy authentication server of the results of the QR code authentication.

2. The authentication system of claim 1, wherein the portable authentication terminal comprises:
a terminal communication unit for performing data communication with the QR authentication server over a wired/wireless data communication network;
a scanning unit for scanning the QR code image displayed on the computer terminal and outputting the scanned QR code image;
a display unit for displaying the QR code information; and
a terminal control unit for detecting QR code information from the QR code image by scanning the QR code image through the scanning unit, displaying the QR code information on the display unit, and transmitting the QR code information.

3. The authentication system of claim 2, wherein:
the QR authentication server encrypts the QR code information using a security key, generates a QR code image corresponding to encrypted QR code information, and provides the QR code image to the legacy authentication server, and
the terminal control unit comprises:
a QR code information acquisition unit for detecting the QR code image through the scanning unit, interpreting the QR code image, and acquiring encrypted QR code information; and
a password authentication processing unit having a decryption unit for receiving a password corresponding to the security key from the user and decrypting the acquired encrypted QR code information.

4. The authentication system of claim 3, wherein the terminal control unit further comprises a QR code integrity checking unit for checking an integrity of the QR code using a hash value included in the decrypted QR code information, and transmitting the QR code information to the QR authentication server when the integrity check is passed.

5. The authentication system of claim 3, wherein the terminal control unit further comprises:
a transaction information detection unit for checking whether financial transaction information is included in the decrypted QR code information, and detecting the financial transaction information and displaying the financial transaction information on the display unit if the financial transaction information is included; and
a user approval verification unit for, after the financial transaction information has been displayed by the transaction information detection unit, displaying a message prompting the user to decide whether to approve the corresponding transaction, and for, when the user selects approval in response to the prompt message, adding details of the approval to the QR code information and transmitting the QR code information to the QR authentication server.

6. The authentication system of claim 5, wherein the user approval verification unit is configured to, when transmitting the QR code information to the QR authentication server, encrypt again the QR code information using a password and transmit the encrypted QR code information.

7. The authentication of claim 1, wherein the legacy authentication server comprises:
a legacy storage unit, including a legacy authentication information database (DB) for storing pieces of legacy authentication information for respective pieces of user identification (ID) information, and a session ID information DB, for storing authentication service information including pieces of session ID information for respective pieces of user ID information; and
a legacy control unit, wherein the legacy control unit comprises:
an authentication type determination unit for determining an authentication request scheme based on the authentication scheme selection information for the authentication request,
a legacy authentication unit for performing legacy authentication with reference to the legacy authentication information DB if the authentication request scheme is found to be legacy authentication upon a determination of the authentication type,
a QR code authentication service subscription unit for determining whether the user of the user ID information is a subscriber to a QR code authentication service through the QR authentication server if the authentication request scheme is found to be QR code authentication upon a determination of the authentication type,
a QR code issuance requesting unit for, when the user is the subscriber to the QR code authentication service, requesting issuance of a QR code by transmitting a QR code generation request signal including the user ID information, and for transmitting a QR code image received in response to the request signal to the computer terminal,
wherein the legacy control unit is configured to, when results of QR code authentication depending on transmission of the QR code image are received from the QR authentication server and indicate success, approve provision of the service.

8. The authentication system of claim 7, wherein the legacy control unit further comprises a session authentication unit for comparing session ID information of user ID information and the session ID information, which are included in the results of the QR code authentication when the QR code authentication results are received, with session ID information registered in a session ID information DB for the user ID information, and performing session authentication based on whether the pieces of session ID information match each other, wherein approval of provision of the service is determined when session authentication succeeds.

9. The authentication system of claim 7, wherein the legacy control unit further comprises a transaction information authentication unit for, when a type of authentication service for the authentication request is one of a transfer, a purchase and payment, and a stock trade, comparing financial transaction information of user ID information and the financial transaction information included in the authentication results with financial transaction information stored in the session ID information DB for the user ID information, and performing authentication of financial transaction information depending on whether the pieces of financial transaction information match each other, wherein approval of provision of the service is determined when authentication of the financial transaction information succeeds.

10. The authentication system of claim 1, wherein the QR authentication server comprises:
a QR storage unit including a QR code generation DB for storing generated QR code information; and
a QR control unit for receiving the QR code generation request signal, generating QR code information, storing the QR code information in the QR code generation DB, providing the QR code information to the legacy authentication server, comparing QR code information received from the portable authentication terminal with QR code information stored in the QR code generation DB to perform authentication, and notifying the legacy authentication server of results of the QR code authentication.

11. The authentication system of claim 10, wherein:
the QR storage unit further comprises a QR authentication service subscriber DB for storing authentication service subscription information including user information of the user and ID information and a password of a portable authentication terminal of the user, and
the QR control unit comprises:
a QR code authentication service registration unit for, when query about subscription/non-subscription to a QR code authentication service is received from the legacy authentication server in response to a QR code authentication request, determining whether subscription/non-subscription to the service has been made with reference to the authentication service subscription information in the QR authentication service subscriber DB and providing results of the determination to the legacy authentication server, and for, when a service subscription request signal including authentication service subscription information is received from the legacy authentication server, storing and registering the authentication service subscription information in the QR authentication service subscriber DB;
a QR code generation unit for, when the QR code generation request signal is received, collecting the QR code information, generating a QR code image for the QR code information, storing the QR code image in the QR code generation DB, and providing the QR code image to the legacy authentication server;
a QR authentication unit for comparing the QR code information, which is received from the portable authentication terminal, with QR code information, which is generated for the QR code image and is stored in the QR code generation DB, thus performing authentication; and
an authentication result notification unit for notifying both the legacy authentication server and the portable authentication terminal of the results of QR code authentication.

12. The authentication system of claim 11, wherein the QR code generation unit comprises:
a QR code generation information collection unit for collecting QR code generation information in response to the QR code generation request signal, wherein the QR code generation information includes a site name of a service server, an authentication service type, financial transaction information, user ID information, and session ID information;
a QR code information generation unit for generating QR code information that includes the QR code generation information, a timestamp, which is a time of issuance of the QR code, and QR ID information; and
a QR code image generation unit for generating a QR code image corresponding to the generated QR code information and transmitting the QR code image to the legacy authentication server.

13. The authentication system of claim 12, wherein:
the QR code generation unit further comprises a QR code encryption unit for encrypting the generated QR code information using a password registered in a QR authentication service subscriber DB for the user ID information of the QR code generation information,
wherein the QR code image generation unit generates a QR code image for the encrypted QR code information.

14. The authentication system of claim 1, wherein the QR control unit further comprises a terminal authentication unit for, when QR code information is received from the portable authentication terminal, performing authentication based on whether terminal ID information of the portable authentication terminal, which is received from the portable authentication terminal, matches terminal ID information, which is mapped to the user ID information of the user of the portable authentication terminal and is stored in the QR authentication service subscriber DB.

15. An authentication method using a Quick Response (QR) code, comprising:
an authentication request procedure of, while a computer terminal is using a certain service provided by a service server, requesting authentication by transmitting a QR code authentication request signal including at least user identification (ID) information and authentication scheme selection information, required to select at least QR code authentication, to a legacy authentication server;
a QR code generation request procedure of, when an authentication request is made in response to reception of a QR code authentication request signal including the authentication scheme selection information required to select QR code authentication from the computer terminal, transmitting, by the legacy authentication server, a QR code generation request signal, which includes QR code generation information including the user ID information, to the QR authentication server, thus requesting generation of a QR code;
a QR code image generation procedure of, when the QR authentication server receives the QR code generation request signal from the legacy authentication server, collecting QR code information in response to the authentication request, generating a QR code image for the collected QR code information, and providing the QR code image to the legacy authentication server;
a QR code provision procedure of transmitting, by the legacy authentication server, the QR code image to the computer terminal;
a QR code display procedure of receiving and displaying, by the computer terminal, the QR code image;
a QR code scan procedure of scanning, by a portable authentication terminal, the QR code image displayed on the computer terminal, acquiring QR code information included in the QR code, and transmitting the acquired QR code information to the QR authentication server;
a QR code authentication procedure of performing, by the QR authentication server, QR code authentication by comparing the QR code information received from the portable authentication terminal with QR code information generated for the user ID information, and transmitting results of QR code authentication to the legacy authentication server; and
a service approval procedure of, when the results of the QR code authentication received from the QR authentication server indicate success of authentication, granting, by the legacy authentication server, final approval for the service.

16. The authentication method of claim 15, wherein the authentication scheme selection information in the authentication request procedure comprises authentication selection information required to select at least one legacy authentication scheme and a QR code authentication scheme, wherein the QR code generation request procedure comprises:
a legacy authentication step of performing legacy authentication depending on legacy authentication selection information included in the authentication selection information; and
a QR code generation request step of requesting generation of a QR code by transmitting a QR code generation request signal, which includes QR code generation information containing the user ID information, to the QR authentication server when legacy authentication succeeds.

17. The authentication method of claim 15, wherein the QR code image generation procedure comprises:
a QR code generation information collection step of, when a QR code generation request signal is received from the legacy authentication server, extracting QR code generation information from the QR code generation request signal;
a QR code information generation step of generating QR code information, which includes the collected QR code generation information and information about a QR code to be generated; and
a QR code image generation step of generating a QR code image corresponding to the generated QR code information, and thereafter providing the QR code image to the legacy authentication server.

18. The authentication method of claim 17, wherein:
the QR code image generation procedure further comprises an encryption step of, when QR code information is collected at the QR code generation information collection step, encrypting the QR code information by applying a password of the corresponding user, registered in the QR authentication service subscriber DB, to the QR code information as a security key, and
at the QR code image generation step, a QR code image for the encrypted QR code information is generated.

19. The authentication method of claim 15, wherein the QR code scan procedure comprises:
a scanning step of scanning, by the portable authentication terminal, a QR code image displayed on the computer terminal;
a QR code information extracting step of analyzing the scanned QR code image and extracting QR code information; and
a QR code transmission step of transmitting the extracted QR code information to the QR authentication server.

20. The authentication method of claim 19, wherein:
in the QR code image generation procedure, the QR authentication server encrypts QR code information using a password preset for the user of the user ID information as a security key, and transmits the encrypted QR code information, and
the QR code scan procedure further comprises a decryption step of, after the QR code information has been extracted, requesting the user to input a password corresponding to the security key and receiving the password from the user, and then decrypting the encrypted QR code information using the password.

21. The authentication method of claim 19, wherein:
the QR code scan procedure further comprises an integrity checking step of performing an integrity check using a hash value included in the QR code information, and
the QR code information is transmitted to the QR authentication server only when the integrity check at the QR code transmission step is passed.

22. The authentication method of claim 15, wherein the QR code authentication procedure comprises:
a terminal authentication step of comparing terminal ID information included in a signal, containing the QR code information and received from the portable authentication terminal, with terminal ID information previously registered in a QR authentication service subscriber DB to correspond to the user ID information, thus performing terminal authentication based on whether pieces of terminal ID information match each other;
a QR code authentication step of, when terminal authentication succeeds, comparing the QR code information with QR code information previously registered for the user of the user ID information, thus performing QR code authentication based on whether pieces of QR code information match each other; and
a QR code authentication notification step of transmitting results of QR code authentication to the legacy authentication server.

23. The authentication method of claim 15, wherein the service approval procedure comprises:
a session authentication step of, when results of QR code authentication are received from the QR authentication server, performing, by the legacy authentication server, session authentication based on whether session ID information included in the results of the QR code authentication matches session ID information stored in a session ID information DB to correspond to the user authentication information included in the results of the QR code authentication; and
a service approval step of granting final approval for the service when session authentication succeeds.

24. The authentication method of claim 23, wherein:
the service approval procedure further comprises a transaction information authentication step of, when a type of authentication service in the authentication request is a financial transaction, comparing financial transaction information included in the results of QR code authentication with financial transaction information that is stored in the session ID information DB and is mapped to the session ID information, thus performing authentication of transaction information based on whether pieces of financial transaction information match each other, and
the service approval step is performed when authentication of the transaction information succeeds.
